(19) United States
(12) Patent Application Publication
(10) Pub. No.: US 2025/0148701 A1
(43) Pub. Date: May 8, 2025

(54) DYNAMIC OVERLAPPING OF MOVING OBJECTS WITH REAL AND VIRTUAL SCENES FOR VIDEO SEE-THROUGH (VST) EXTENDED REALITY (XR)

(71) Applicant: Samsung Electronics Co., Ltd., Suwon-si (KR)

(72) Inventor: Yingen Xiong, Mountain View, CA (US)

(21) Appl. No.: 18/759,361

(22) Filed: Jun. 28, 2024

Related U.S. Application Data
(60) Provisional application No. 63/596,517, filed on Nov. 6, 2023.

(51) Int. Cl. G06T 15/40; G06T 7/13; G06T 7/55; G06T 19/00

(52) U.S. Cl. CPC G06T 15/40; G06T 7/13; G06T 7/55; G06T 19/006; G06T 2207/20081; G06T 2207/20212; G06T 2207/30196

(57) ABSTRACT

A method includes obtaining image frames of a scene captured using one or more imaging sensors of a video see-through (VST) extended reality (XR) device and depth data associated with the scene. The image frames capture a moving object and static scene contents, and the moving object includes a portion of a body of a user. The method also includes generating masks associated with the moving object using a machine learning model trained to separate pixels corresponding to human skin from other portions of the scene. The method further includes reconstructing images of the moving object and images of the static scene contents. In addition, the method includes combining the images of the moving object, the images of the static scene contents, and one or more virtual features to generate combined images and rendering the combined images for presentation on at least one display of the VST XR device.

### CROSS-REFERENCE TO RELATED APPLICATIONS AND PRIORITY CLAIM

This application claims priority under 35 U.S.C. § 119 (e) to U.S. Provisional Patent Application No. 63/596,517 filed on Nov. 6, 2023. This provisional patent application is hereby incorporated by reference in its entirety.

### TECHNICAL FIELD

This disclosure relates generally to extended reality (XR) systems and processes. More specifically, this disclosure relates to dynamic overlapping of moving objects with real and virtual scenes for video see-through (VST) XR.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to dynamic overlapping of moving objects with real and virtual scenes for video see-through (VST) extended reality (XR).

In a first embodiment, a method includes obtaining image frames of a scene captured using one or more imaging sensors of a VST XR device and depth data associated with the scene. The image frames capture a moving object and static scene contents, and the moving object includes a portion of a body of a user. The method also includes generating masks associated with the moving object using a machine learning model trained to separate pixels corresponding to human skin from other portions of the scene. The method further includes reconstructing images of the moving object based on the image frames, the depth data, and the masks and reconstructing images of the static scene contents based on the image frames and the depth data. In addition, the method includes combining the images of the moving object, the images of the static scene contents, and one or more virtual features to generate combined images and rendering the combined images for presentation on at least one display of the VST XR device.

In a second embodiment, a VST XR device includes one or more imaging sensors, at least one display, and at least one processing device. The at least one processing device is configured to obtain image frames of a scene captured using the one or more imaging sensors and depth data associated with the scene. The image frames capture a moving object and static scene contents, and the moving object includes a portion of a body of a user. The at least one processing device is also configured to generate masks associated with the moving object using a machine learning model trained to separate pixels corresponding to human skin from other portions of the scene. The at least one processing device is further configured to reconstruct images of the moving object based on the image frames, the depth data, and the masks and reconstruct images of the static scene contents based on the image frames and the depth data. In addition, the at least one processing device is configured to combine the images of the moving object, the images of the static scene contents, and one or more virtual features to generate combined images and render the combined images for presentation on the at least one display.

In a third embodiment, a non-transitory machine readable medium contains instructions that when executed cause at least one processor of a VST XR device to obtain image frames of a scene captured using one or more imaging sensors of the VST XR device and depth data associated with the scene. The image frames capture a moving object and static scene contents, and the moving object includes a portion of a body of a user. The non-transitory machine readable medium also contains instructions that when executed cause the at least one processor to generate masks associated with the moving object using a machine learning model trained to separate pixels corresponding to human skin from other portions of the scene. The non-transitory machine readable medium further contains instructions that when executed cause the at least one processor to reconstruct images of the moving object based on the image frames, the depth data, and the masks and reconstruct images of the static scene contents based on the image frames and the depth data. In addition, the non-transitory machine readable medium contains instructions that when executed cause the at least one processor to combine the images of the moving object, the images of the static scene contents, and one or more virtual features to generate combined images and render the combined images for presentation on at least one display of the VST XR device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates a first example architecture supporting dynamic overlapping of moving objects with real and virtual scenes for video see-through (VST) extended reality (XR) in accordance with this disclosure;

FIGS. 3A and 3B illustrate a second example architecture supporting dynamic overlapping of moving objects with real and virtual scenes for VST XR in accordance with this disclosure;

FIGS. 4 and 5 illustrate an example mask generation function for a moving object for VST XR in accordance with this disclosure;

FIG. 6 illustrates an example process for scene reconstruction for VST XR in accordance with this disclosure;

FIG. 7 illustrates an example overlapping process between a moving object and static scene contents for VST XR in accordance with this disclosure;

FIGS. 8A through 8C illustrate example use cases for dynamic overlapping of moving objects with real and virtual scenes for VST XR in accordance with this disclosure; and

FIG. 9 illustrates an example method for dynamic overlapping of moving objects with real and virtual scenes for VST XR in accordance with this disclosure.

### DETAILED DESCRIPTION

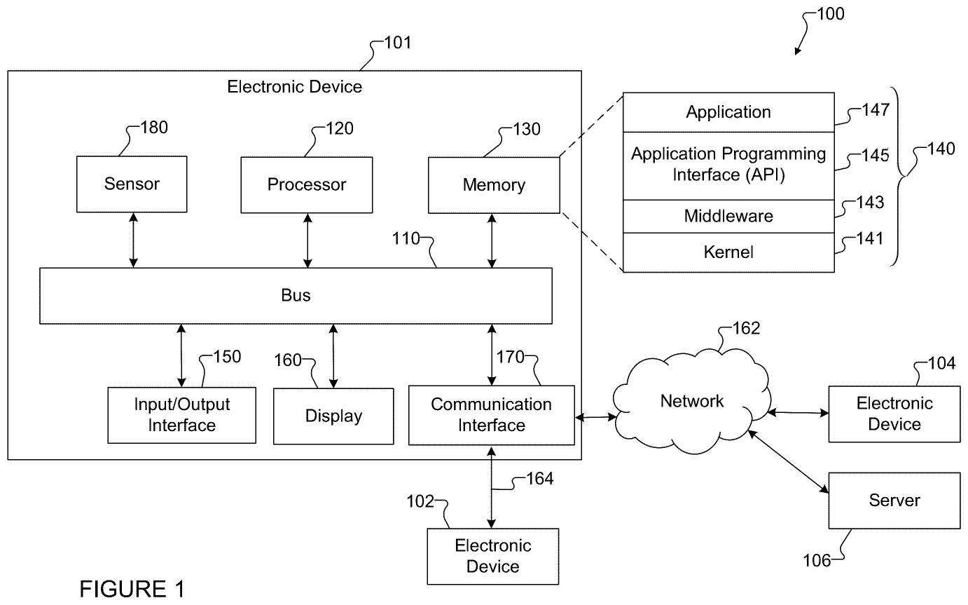

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

Unfortunately, VST XR devices can suffer from various problems when there are moving objects (including users' hands) within scenes being imaged. For example, a moving object typically occludes one portion of static content in a scene in one image frame and another portion of the static content in the scene in another image frame, and it can be difficult for VST XR devices to compensate for this without creating noticeable visual artifacts. Also, VST XR devices can often present virtual features (such as virtual objects) incorrectly in relation to moving objects. In some cases, a user of a VST XR device may provide input to the VST XR device by interacting with a real or virtual keyboard, and the inability to effectively generate images showing the user's hand movements and hand overlapping with the keyboard can interfere with convenient interaction with the VST XR device.

This disclosure provides various techniques supporting dynamic overlapping of moving objects with real and virtual scenes for VST XR. As described in more detail below, image frames of a scene can be obtained using one or more imaging sensors of a VST XR device, and depth data associated with the scene can be obtained. The image frames can capture a moving object and static scene contents, and the moving object can include a portion of a body of a user (such as one or more of the user's hands). Masks associated with the moving object can be generated using a machine learning model trained to separate pixels corresponding to human skin from other portions of the scene. Images of the moving object can be reconstructed based on the image frames, the depth data, and the masks, and images of the static scene contents can be reconstructed based on the image frames and the depth data. The images of the moving object, the images of the static scene contents, and one or more virtual features can be combined to generate combined images, and the combined images can be rendered for presentation on at least one display of the VST XR device.

In this way, the disclosed techniques provide an efficient mechanism to address moving objects (such as users' hands) overlapping with captured static scene contents. For example, moving objects and static scene contents can be reconstructed effectively, and the moving objects can overlap the static scene contents while parallax correction and hole filling are achieved. Disoccluded areas (referring to areas of the scene that are covered by moving objects in some image frames but not in other image frames) can be effectively identified so that hole filling can occur, which significantly reduces the appearance of visual artifacts. As a result, final views of the scene can be created with correct parallax for the moving objects, the static scene contents, and one or more virtual objects. As a particular example of this, the disclosed techniques can be used to effectively reconstruct a keyboard in a captured scene and to overlap reconstructed hands of the user with the keyboard, which can facilitate easier and more effective interaction between the user and the VST XR device.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to dynamic overlapping of moving objects with real and virtual scenes for VST XR.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform dynamic overlapping of moving objects with real and virtual scenes for VST XR. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to dynamic overlapping of moving objects with real and virtual scenes for VST XR.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

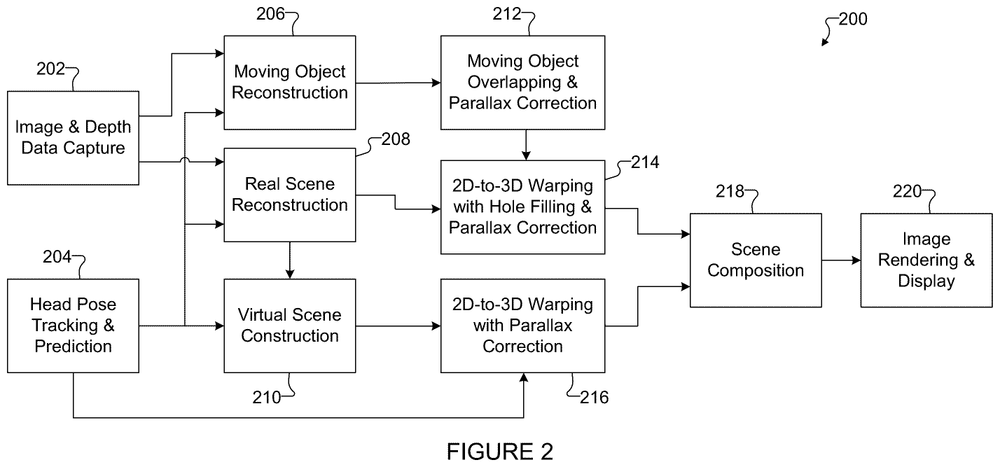

FIG. 2 illustrates a first example architecture 200 supporting dynamic overlapping of moving objects with real and virtual scenes for VST XR in accordance with this disclosure. For ease of explanation, the architecture 200 of FIG. 2 is described as being implemented using the electronic device 101 in the network configuration 100 of FIG. 1. However, the architecture 200 may be implemented using any other suitable device(s) and in any other suitable system(s).

As shown in FIG. 2, the architecture 200 includes an image and depth data capture operation 202, which generally operates to obtain captured image frames of a scene and depth data associated with the scene. For example, the image and depth data capture operation 202 can be used to obtain see-through image frames captured using one or more see-through cameras or other imaging sensors 180 of a VST XR device. In some cases, the image and depth data capture operation 202 may be used to obtain see-through image frames at a desired frame rate, such as 30, 60, 90, or 120 frames per second. Each see-through image frame can have any suitable size, shape, and resolution and include image data in any suitable domain. As particular examples, each see-through image frame may include RGB image data, YUV image data, or Bayer or other raw image data. The image and depth data capture operation 202 can also be used to obtain depth data related to the image frames being captured. For instance, at least one depth sensor 180 used in or with the VST XR device may capture depth data within the scene being imaged using the see-through camera(s). Any suitable type of depth sensor(s) 180 may be used, such as light detection and ranging (LIDAR) or time-of-flight (ToF) depth sensors. In some cases, the depth data that is obtained can have a resolution that is less than (and possibly significantly less than) the resolution of the captured image frames. For example, the depth data may have a resolution that is equal to or less than half a resolution of each of the captured image frames. As a particular example, the captured image frames may have a 3K or 4K resolution, and the depth data may have a resolution of 320 depth values by 320 depth values.

The architecture 200 also includes a head pose tracking and prediction operation 204, which generally operates to obtain information related to the head pose of a user using the VST XR device and predict how the user's head pose is likely to change over time. For example, the head pose tracking and prediction operation 204 may obtain inputs from an IMU sensor, a head pose tracking camera, or other sensor(s) 180 of the electronic device 101 when the image frames are being captured. The head pose tracking and prediction operation 204 can also use at least one model of the user's head pose to predict, based on prior and current head poses or head pose changes of the user, how the user's head pose might change in the future. This can be useful since there is typically a delay between capture of the image frames and display of rendered images based on those captured image frames, and it is possible for the user to move his or her head during that intervening time period.

The obtained image frames and depth data are provided to a moving object reconstruction operation 206 and a real scene reconstruction operation 208. The moving object reconstruction operation 206 generally operates to generate images of one or more moving objects captured in the image frames. For example, the moving object reconstruction operation 206 can generate masks associated with each moving object in the image frames, where the masks identify the boundary of each moving object in the image frames. In some cases, the moving object(s) in the image frames can include one or more hands or other body parts of the user, and the moving object reconstruction operation 206 can use a skin color model or other machine learning model that is trained to separate pixels corresponding to human skin from other portions of the scene. The masks effectively allow the moving object reconstruction operation 206 to track the boundary of each moving object across the image frames, which allows images containing just the moving object(s) to be generated. The real scene reconstruction operation 208 generally operates to generate images of static scene contents captured in the image frames, such as one or more stationary or background objects. For instance, the real scene reconstruction operation 208 may use the same masks as the moving object reconstruction operation 206 to generate images that omit the moving object(s), which allows images containing just the static scene contents to be generated.

A virtual scene construction operation 210 generally operates to create one or more virtual features to be included in images displayed to the user of the VST XR device. For example, the virtual scene construction operation 210 may generate one or more virtual objects to be positioned at one or more desired locations in the images displayed to the user of the VST XR device. The one or more virtual objects may represent or include any suitable virtual content to be presented to the user, and the virtual content can vary depending on the application. In general, this disclosure is not limited to use with any particular type(s) of virtual objects or other virtual content. The virtual content generated by the virtual scene construction operation 210 can be said to form virtual scenes.

A moving object overlapping and parallax correction operation 212 generally operates to determine how the images of the moving object(s) should be overlapped with the images of the static scene contents. For example, the moving object overlapping and parallax correction operation 212 can determine where each image of a moving object should be placed relative to the static scene contents in a corresponding image of the static scene contents. The moving object overlapping and parallax correction operation 212 also operates to adjust the images of the moving object(s) in order to provide correct parallax. For instance, the moving object overlapping and parallax correction operation 212 can estimate the depth of each moving object (or the depths of various points of each moving object) in order to ensure that the images of the moving object(s) are positioned to provide the correct parallax from the perspective of the user.

A two-dimensional to three-dimensional (2D-to-3D) warping operation 214 generally operates to overlap and warp the images of the moving object(s) and the images of the static scene contents. For example, the 2D-to-3D warping operation 214 can use a predicted head pose of the user received from the head pose tracking and prediction operation 204 to determine how to warp the overlapped images of the moving object(s) and the static scene contents in order to compensate for predicted movement of the user. The 2D-to-3D warping operation 214 can also perform hole filling, which can involve identifying locations where image data is missing in the 3D version of the scene and filling in that image data (such as by using image data from one or more other image frames). The 2D-to-3D warping operation 214 can further perform parallax correction so that the resulting warped images have suitable parallax based on the predicted head pose of the user. Similarly, a 2D-to-3D warping operation 216 generally operates to warp the virtual content generated by the virtual scene construction operation 210. For instance, the 2D-to-3D warping operation 216 can use the predicted head pose of the user received from the head pose tracking and prediction operation 204 to determine how to warp the virtual scenes generated by the virtual scene construction operation 210 in order to compensate for predicted movement of the user. The 2D-to-3D warping operation 216 can also perform parallax correction so that the resulting warped virtual scenes have suitable parallax based on predicted head poses of the user.

This results in the generation of reconstructed images of actual/real scenes by the warping operation 214 and reconstructed images of virtual scenes by the warping operation 216. A scene composition operation 218 generally operates to combine the reconstructed images of the actual scenes and the reconstructed images of the virtual scenes. For example, the scene composition operation 218 may overlay the reconstructed images of the virtual scenes over the reconstructed images of the actual scenes. This leads to the generation of combined images, which may also be referred to as composited images. An image rendering and display operation 220 generally operates to render the combined images and initiate presentation of the rendered images on one or more displays 160 of the VST XR device. Depending on the implementation, rendered images can be presented on separate displays 160 (such as left and right display panels) or on separate portions of the same display 160 (such as left and right portions of a common display panel).

Although FIG. 2 illustrates a first example of an architecture 200 supporting dynamic overlapping of moving objects with real and virtual scenes for VST XR, various changes may be made to FIG. 2. For example, various components or functions in FIG. 2 may be combined, further subdivided, replicated, omitted, or rearranged and additional components or functions may be added according to particular needs.

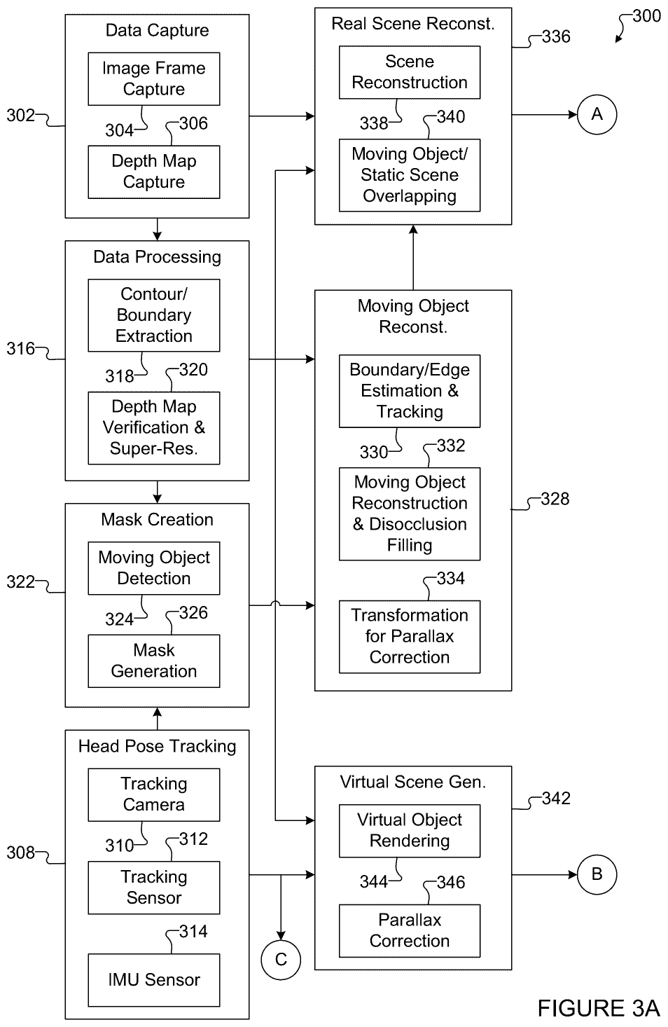

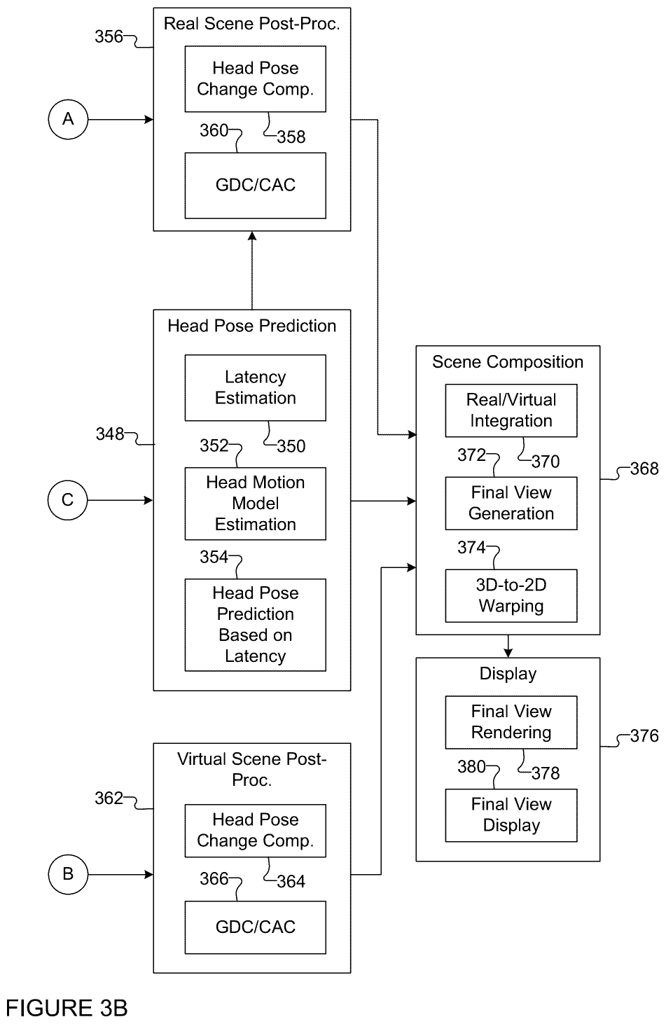

FIGS. 3A and 3B illustrate a second example architecture 300 supporting dynamic overlapping of moving objects with real and virtual scenes for VST XR in accordance with this disclosure. For ease of explanation, the architecture 300 of FIGS. 3A and 3B is described as being implemented using the electronic device 101 in the network configuration 100 of FIG. 1. However, the architecture 300 may be implemented using any other suitable device(s) and in any other suitable system(s).

As shown in FIG. 3A, a data capture operation 302 generally operates to obtain image frames and associated depth maps. For example, the data capture operation 302 can include an image frame capture function 304 used to obtain see-through image frames captured using one or more see-through cameras or other imaging sensors 180 of a VST XR device. The image frames may be captured at any suitable frame rate, have any suitable size, shape, and resolution, and include image data in any suitable domain. The data capture operation 302 can also include a depth map capture function 306 used to obtain depth maps or other depth data from one or more depth sensors 180 of the VST XR device. The depth data can have any suitable size, shape, and resolution. Any suitable type of depth sensor(s) 180 may be used, such as LIDAR or ToF depth sensors.

A head pose tracking operation 308 generally operates to obtain information related to the head pose of a user using the VST XR device and how the user's head pose changes over time. For example, the head pose tracking operation 308 may obtain inputs from one or more of a head pose tracking camera 310, a head pose tracking sensor 312, and/or an IMU sensor 314 of the electronic device 101 when the image frames are being captured. The head pose tracking operation 308 can also track how these inputs are changing over time.

A depth processing operation 316 generally operates to process the obtained image frames and the obtained depth maps or other depth data. For example, a contour/boundary extraction function 318 can process the image frames and depth data in order to estimate contours and boundaries of objects or other content captured in the image frames. In some cases, the contour/boundary extraction function 318 can process the image frames and the depth data in order to identify estimated outer contours or outer boundaries of objects within the scene. One or more of the detected objects here may represent one or more moving objects. A depth map verification and super-resolution function 320 can process stereo pairs of image frames along with the depth data in order to verify depth measurements in the depth data and to increase the resolution of the depth data. For instance, the depth map verification and super-resolution function 320 can use disparities in the stereo pairs of image frames to estimate depths within the scene, combine those estimated depths with depths generated using one or more depth sensors 180, perform hole filling to fill in missing depths, and filter the resulting collection of depths. This is often referred to as depth densification and can result in the generation of dense depth maps or other depth data having higher resolution.

A mask creation operation 322 generally operates to detect moving objects captured in the image frames and generate masks associated with the moving objects. For example, a moving object detection function 324 can process image frames, dense depth maps, or other information in order to identify one or more moving objects captured in the image frames. A mask generation function 326 can generate at least one mask for the moving object(s) detected in each of the image frames. In some cases, each mask may represent a binary mask in which each pixel has a value indicating that a corresponding pixel in an image frame either is or is not associated with a moving object. In some embodiments, the mask generation function 326 may perform segmentation in order to differentiate the moving object(s) from other portions of the image frames. In particular embodiments, the mask creation operation 322 can use a trained skin color model or other trained machine learning model to separate pixels corresponding to human skin from other portions of the scene. The machine learning model may represent any suitable machine learning architecture that can be trained to generate masks, such as a deep neural network. Note that in whatever manner the machine learning model operates (such as identifying areas where the user's skin is visible or performing segmentation of body parts), the machine learning model effectively operates to separate image pixels corresponding to human skin from other portions of a scene.

The dense depth maps or other depth data generated by the depth processing operation 316 and the masks generated by the mask creation operation 322 are provided to a moving object reconstruction operation 328, which generally operates to generate reconstructed images of any moving objects in the image frames. For example, a boundary/edge estimation and tracking function 330 can be used to estimate the edges or boundaries of each detected moving object within the captured image frames. In some cases, the boundary/edge estimation and tracking function 330 can use the results from the contour/boundary extraction function 318 and/or from the mask generation function 326 to identify the edges or boundaries of each detected moving object, or the boundary/edge estimation and tracking function 330 can separately identify the edges or boundaries of each detected moving object. The boundary/edge estimation and tracking function 330 can also track the edges or boundaries of each detected moving object over time, such as by identifying the edges or boundaries in each image frame of a sequence of captured image frames.

A moving object reconstruction and disocclusion filling function 332 can be used to reconstruct an image of each moving object associated with each captured image frame. For example, the moving object reconstruction and disocclusion filling function 332 can isolate each moving object in each captured image frame and perform hole filling. As noted above, hole filling can involve recreating image content in at least one area that was previously occluded (but that is no longer occluded) due to movement of the moving object(s). Any suitable technique may be used to perform hole filling, such as by recreating image content in one image frame based on image content in one or more other image frames. A transformation function 334 can be used to transform each image of a moving object to provide for parallax correction. For instance, the transformation function 334 can be used to warp the images of the moving objects in order to provide the desired parallax.

The captured image frames, depth data, and images of the reconstructed moving objects are provided to a real scene reconstruction operation 336, which generally operates to generate images of reconstructed static scene contents captured in the image frames and overlap the images of the reconstructed moving objects with the images of the reconstructed static scene. For example, a scene reconstruction function 338 can generate images of the static scene contents captured in the image frames, such as by excluding portions of the image frames that contain the moving object(s). A moving object/static scene overlapping function 340 can be used to place the images of the moving object(s) over the images of the static scene contents. In some cases, for instance, the moving object/static scene overlapping function 340 can overlay the images of the moving object(s) in order to position the moving object(s) in suitable location(s) within the larger images of the static scene contents.

A virtual scene generation operation 342 generally operates to generate virtual scenes to be combined with the images of the real scenes. For example, a virtual object rendering function 344 can be used to generate one or more virtual objects or other virtual content to be inserted into images. Again, any suitable virtual content may be generated here. A parallax correction function 346 can be used to transform or otherwise modify the one or more virtual objects or other virtual content in order to provide the desired parallax for the virtual content. In some cases, the dense depth maps or other depth data provided by the depth processing operation 316 can be used to obtain the correct parallax for the virtual content.

As shown in FIG. 3B, a head pose prediction operation 348 generally operates to estimate what the user's head pose will be when rendered images based on the captured image frames are displayed to the user. For example, a latency estimation function 350 can be used to identify the estimated latency between capture of image frames and display of rendered images. As a particular example, the latency estimation function 350 may estimate the amount of time needed for various operations in the architecture 300 to be performed, such as by identifying times between when image frames are captured and times when other functions of the architecture 300 are completed. A head motion model estimation function 352 can be used to process head pose information associated with the user in order to build a model of the user's head pose. For instance, the model can identify how the user's head pose changes over time based on different starting positions and movements. A head pose prediction function 354 can apply this model to information from the head pose tracking operation 308 to estimate what the head pose of the user is likely to be after a period of time equal to the estimated latency elapses. In other words, the head pose prediction function 354 can use the model and information associated with the user's head pose to estimate the user's head pose when rendered images will be presented to the user.

A real scene post-processing operation 356 generally operates to modify the overlapped images of the moving object(s) and the static scene contents. For example, a head pose change compensation function 358 can modify the overlapped images of the moving object(s) and the static scene contents based on the predicted head pose of the user. As a particular example, the head pose change compensation function 358 can rotate and/or translate the overlapped images so that the overlapped images are suitable for presentation at the user's predicted head pose.

A geometric distortion correction (GDC)/chromatic aberration correction (CAC) function 360 can modify the overlapped images to account for distortions created in displayed images. For instance, in many VST XR devices, rendered images are presented on one or more displays 160, and rendered images are often viewed by the user through left and right display lenses positioned between the user's eyes and the display(s) 160. However, the display lenses may create geometric distortions when displayed images are viewed, and the display lenses may create chromatic aberrations when light passes through the display lenses. The GDC/CAC function 360 can make adjustments to the overlapped images so that the resulting images pre-compensate for the expected geometric distortions and the chromatic aberrations. Thus, the GDC/CAC function 360 may determine how images should be pre-distorted to compensate for the subsequent geometric distortions and chromatic aberrations created when the images are displayed and viewed through the display lenses. In some cases, the GDC/CAC function 360 may operate based on a display lens GDC and CAC model, which can mathematically represent the geometric distortions and chromatic aberrations created by the display lenses.

Similarly, a virtual scene post-processing operation 362 generally operates to modify virtual scenes. For example, a head pose change compensation function 364 can modify virtual scenes based on the predicted head poses of the user. As a particular example, the head pose change compensation function 364 can rotate and/or translate the virtual scenes so that the virtual scenes are suitable for presentation at the user's predicted head pose. A GDC/CAC function 366 can modify the virtual scenes to account for distortions created in displayed images. For instance, the GDC/CAC function 366 can make adjustments to the virtual scenes so that the resulting images pre-compensate for the expected geometric distortions and the chromatic aberrations caused by the display lenses of the VST XR device. In some cases, the GDC/CAC function 366 may operate based on the display lens GDC and CAC model.

A scene composition operation 368 generally operates to produce final views of a scene for presentation to the user. For example, a real/virtual integration function 370 can be used to combine the reconstructed images of actual scenes and the reconstructed images of virtual scenes to generate combined images. As a particular example, the real/virtual integration function 370 may overlap the reconstructed images of the virtual scenes onto the reconstructed images of the actual scenes. A final view generation function 372 can process the combined images and perform any additional refinements or modifications needed or desired, and the resulting images can represent the final views of the scene. A 3D-to-2D warping function 374 can be used to warp the final views of the scene into 2D images. A display operation 376 generally operates to present the 2D images to the user. For instance, a final view rendering function 378 can render the 2D images into a form suitable for transmission to at least one display 160. A final view display function 380 can initiate display of the rendered images, such as by providing the rendered images to one or more displays 160.

Although FIGS. 3A and 3B illustrate a second example of an architecture 300 supporting dynamic overlapping of moving objects with real and virtual scenes for VST XR, various changes may be made to FIGS. 3A and 3B. For example, various components or functions in FIGS. 3A and 3B may be combined, further subdivided, replicated, omitted, or rearranged and additional components or functions may be added according to particular needs. As a particular example, the architecture 300 is shown as applying head pose change compensation separately to reconstructed images of actual scenes and reconstructed images of virtual scenes. In other cases, head pose change compensation may be applied to combined images generated by the scene composition operation 368.

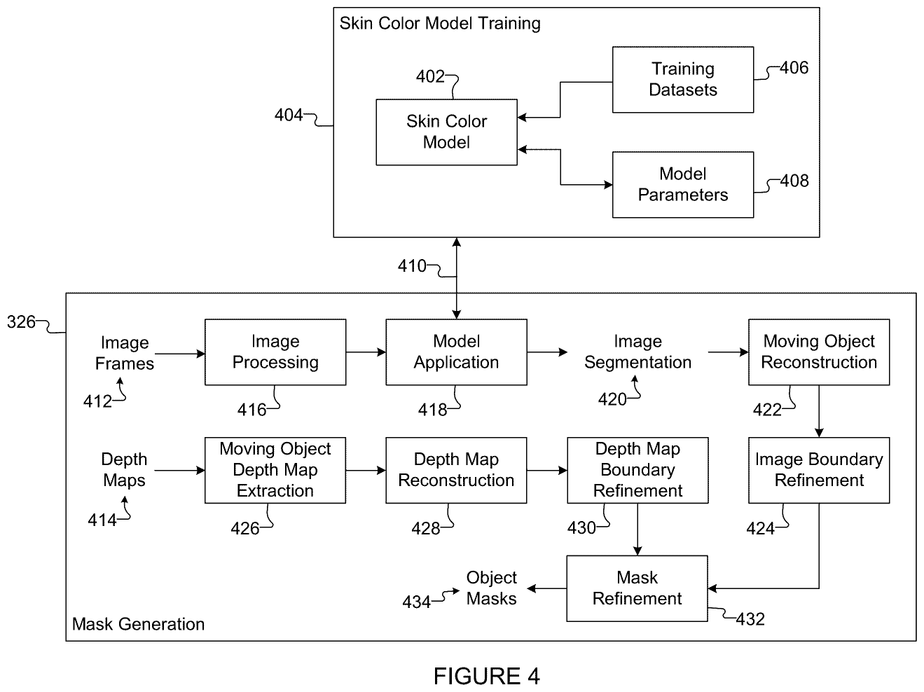

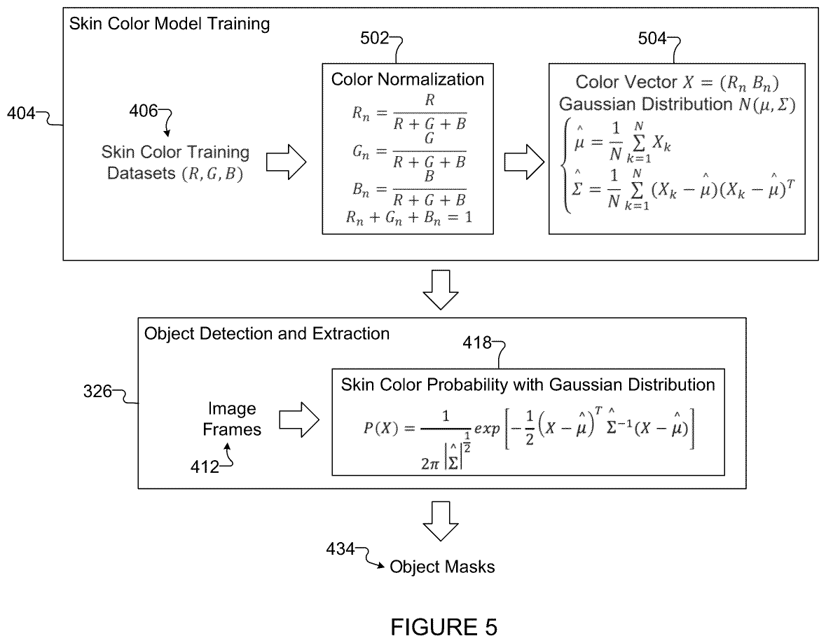

FIGS. 4 and 5 illustrate an example mask generation function 326 for a moving object for VST XR in accordance with this disclosure. As shown in FIG. 4, the mask generation function 326 uses a trained skin color model 402, which represents a machine learning model trained to identify a user' skin within image frames. In this example, the mask generation function 326 includes or is used in conjunction with a skin color model training operation 404, which generally operates to train the skin color model 402. Note that the skin color model training operation 404 may be performed on the VST XR device, or the skin color model training operation 404 could be performed remotely (such as on the server 106) with the resulting trained skin color model 402 deployed to the VST XR device for use.

One or more training datasets 406 can be used to train the skin color model 402. For example, the training dataset(s) 406 may include training images in which portions of people's bodies are visible, along with ground truths that identify which areas of the training images include visible skin of the people in the training images. During the skin color model training operation 404, the skin color model 402 can process the training images and generate estimates of where people's skin is visible, and the estimates can be compared to the ground truths. Differences between the estimates and the ground truths are used to calculate a loss, and weights or other parameters 408 of the skin color model 402 can be adjusted if the loss exceeds a threshold. The adjusted skin color model 402 can again process training images, the resulting loss can again be compared to the threshold, and additional adjustments to the weights or other parameters 408 of the skin color model 402 can be made. This can be repeated any number of times, typically until the loss no longer exceeds the threshold, which is indicative of the skin color model 402 being trained to generate estimates with at least a desired level of accuracy. If the skin color model training operation 404 is performed on a device other than the VST XR device, a deployment operation 410 can be used to send the trained skin color model 402 to the VST XR device, such as via the Internet.

The mask generation function 326 receives and processes image frames 412 and depth maps 414. In some cases, the image frames 412 can be provided by the data capture operation 302, and the depth maps 414 may represent dense depth maps generated by the depth processing operation 316. An image processing function 416 can perform one or more pre-processing functions involving the image frames 412, such as de-noising and image enhancement functions.

A model application function 418 applies the trained skin color model 402 to the processed image frames in order to determine whether any of the processed image frames includes one or more parts of the user's body, such as the user's hands. This results in image segmentations 420, which can segment the user's hands or other body parts from other portions of each of the image frames 412. A moving object reconstruction function 422 can process the image segmentation 420 for each image frame 412 and generate an initial mask for each object that is detected as being a part of the user's body (as defined by the user's skin being visible). For example, the model application function 418 may generate probabilities that pixels or other portions of the image frames 412 include different skin tones, and the moving object reconstruction function 422 can generate initial masks based on those probabilities. An image boundary refinement function 424 can use the initial masks to extract and refine image boundaries for each detected object. For instance, the image boundary refinement function 424 may smooth the image boundaries for each detected object and treat separate objects that are adequately close together as single objects.

The depth maps 414 are provided to a moving object depth map extraction function 426, which can extract depth maps or other depth data related to each moving object from the depth maps 414. For example, the moving object depth map extraction function 426 could isolate portions of the depths maps 414 related to depths of each moving object. A depth map reconstruction function 428 can process the extracted depth maps in order to reconstruct any missing depth data from the extracted depth maps, such as by filling in any holes or other missing data. A depth map boundary refinement function 430 can refine object boundaries for each detected object in the depth maps. For instance, the depth map boundary refinement function 430 may smooth the depth map boundaries for each detected object and treat separate objects that are adequately close together as single objects.

The image boundaries identified by the image boundary refinement function 424 and the depth map boundaries identified by the depth map boundary refinement function 430 are provided to a mask refinement function 432, which processes the image boundaries and the depth map boundaries to generate final object masks 434 for the moving object(s). For example, the mask refinement function 432 may combine the image boundaries and the depth map boundaries in order to precisely identify the boundaries of the user's hands or other moving objects within the scene. The generated object masks 434 can be used for moving object reconstruction and final view generation as discussed above.

FIG. 5 illustrates one example of how the skin color model 402 may be trained and used. In this example, the skin color model training operation 404 includes a color normalization function 502, which normalizes pixel colors (such as red, green, and blue colors) in the one or more training datasets 406. In some cases, this normalization may be expressed as follows:

$$\{ \begin{matrix}{R}_{n} = \frac{R}{R + G + B} \\ {G}_{n} = \frac{G}{R + G + B} \\ {B}_{n} = \frac{B}{R + G + B}\end{matrix}$$

$$where :$$

$${R}_{n} + {G}_{n} + {B}_{n} = 1$$

Here, R represents each red pixel value, G represents each green pixel value, and B represents each blue pixel value. Also, Rₙ represents each normalized red pixel value, Gₙ represents each normalized green pixel value, and Bₙ represents each normalized blue pixel value. A color vector generation function 504 generates color vectors based on the normalized pixel colors and fits the color vectors to a Gaussian distribution. Each color vector may be defined as X=(Rₙ, Bₙ), and the Gaussian distribution can be defined as N(μ, Σ). In some cases, the fitting by the color vector generation function 504 can be expressed as follows:

$$\{ \begin{matrix}\hat{μ} = \frac{1}{N} {\sum }_{k = 1}^{N} {X}_{k} \\ \hat{Σ} = \frac{1}{N} {\sum }_{k = 1}^{N} ( {X}_{k} - \hat{μ} ) {( {X}_{k} - \hat{μ} )}^{T}\end{matrix}$$

Here, \hat{μ} represents the maximum likelihood estimation of the mean vector μ, \hat{Σ} represents the maximum likelihood estimation of the covariance matrix Σ, and N(\hat{μ}, \hat{Σ}) represents an estimated skin color Gaussian model.

The mask generation function 326 applies the skin color Gaussian model (the trained skin color model 402) to the image frames 412. In some embodiments, this may involve building a skin color filter based on estimated skin color probabilities. In some cases, an estimated skin color probability can be expressed as follows:

$$P ( X ) = \frac{1}{2 π \vert \hat{Σ} {\vert}^{\frac{1}{2}}} exp [ - \frac{1}{2} {( X - \hat{μ} )}^{T} {\hat{Σ}}^{- 1} ( X - \hat{μ} ) ]$$

Here, (\hat{μ}, \hat{Σ}) represents the maximum likelihood estimation of the trained skin color model 402. By applying the trained skin color model 402 to color image frames 412 with a defined threshold, skin color pixels can be segmented from other contents of the image frames 412. Using the segmented skin color regions, hole filling and edge refinement guided by the image frames 412 can be performed, and object masks 434 can be generated as described above.

Although FIGS. 4 and 5 illustrate one example of a mask generation function 326 for a moving object for VST XR, various changes may be made to FIGS. 4 and 5. For example, the mask generation function 326 may use any other suitable technique to generate masks for moving objects. As a particular example, the mask generation function 326 may use any suitable machine learning model to separate pixels corresponding to human skin from other portions of the scene.

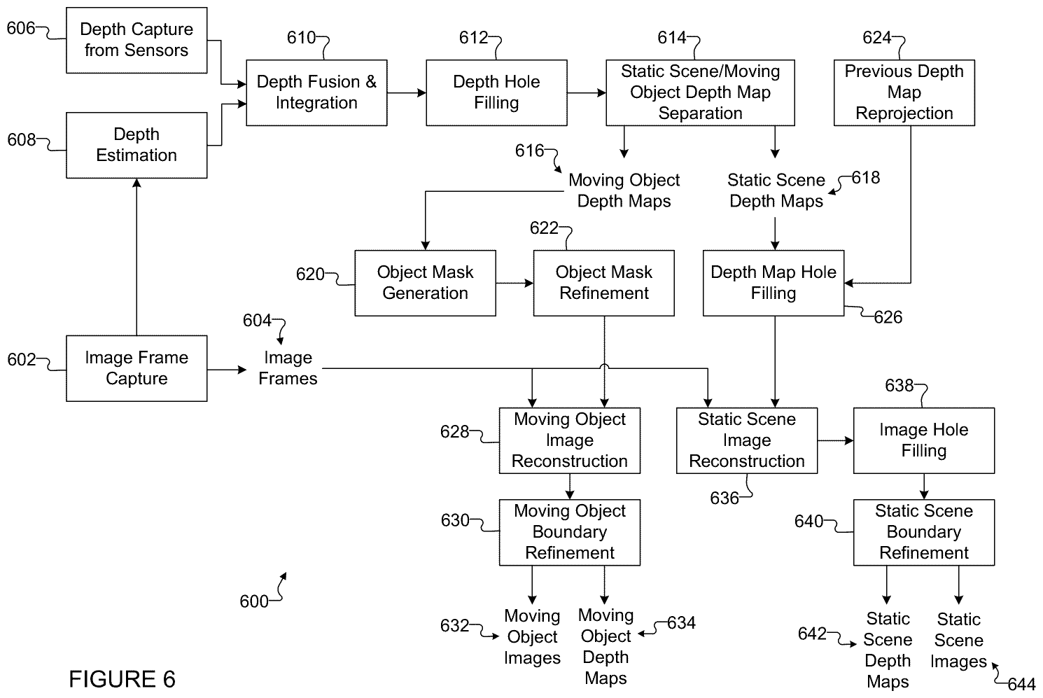

FIG. 6 illustrates an example process 600 for scene reconstruction for VST XR in accordance with this disclosure. More specifically, FIG. 6 illustrates how various operations of the architecture 300 may be used to reconstruct images of scenes. For ease of explanation, the process 600 of FIG. 6 is described as being implemented using the electronic device 101 in the network configuration 100 of FIG. 1. However, the process 600 may be implemented using any other suitable device(s) and in any other suitable system(s).

As shown in FIG. 6, an image frame capture function 602 generally operates to capture or otherwise obtain image frames 604. A depth capture function 606 generally operates to capture or otherwise obtain depth data from one or more depth sensors 180, such as from one or more LIDAR or ToF depth sensors. A depth estimation function 608 generally operates to estimate depths within scenes, such as based on stereo pairs of image frames 604. In some embodiments, the functions 602, 606, 608 may represent or be included in the data capture operation 302. A depth fusion and integration function 610 generally operates to combine depth data from the depth capture function 606 and the depth estimation function 608. A depth hole filling function 612 generally operates to fill in missing depth values, such as via interpolation or filling in depths for one image frame based on depths for one or more other image frames. In some embodiments, the functions 610 and 612 may represent or be included in the depth processing operation 316.

A depth map separation function 614 can divide the resulting dense depth maps or other dense depth data into depth maps 616 associated with any moving objects and depth maps 618 associated with static scene contents. The depth maps 616 are provided to an object mask generation function 620, which can generate object masks for the moving object(s) in each image frame 604. In some cases, this may be done using the trained skin color model 402. An object mask refinement function 622 can refine the object masks, such as by smoothing the object masks. The depth maps 618 may include holes caused by disocclusions, which means at least one moving object moves and reveals one or more portions of the scene that were previously occluded by the moving object. To help compensate for these holes, a reprojection function 624 generally operates to reproject at least one previous depth map (such as one or more previous depth maps associated with one or more previous image frames 604) onto a current depth map for a current image frame 604. This reprojection can be used by a depth map hole filling function 626 to fill in the holes of the depth map 618 for the current image frame 604 based on the reprojection(s) of the prior image frame(s). In some embodiments, the functions 614, 620, 622, 624, 626 may represent or be included in the mask creation operation 322.

The image frames 604 and the refined object masks generated by the object mask refinement function 622 are provided to a moving object image reconstruction function 628, which generates initial images of each moving object. A moving object boundary refinement function 630 processes the initial images and the refined object masks in order to more accurately define the boundaries of the moving objects. The moving object boundary refinement function 630 can thereby generate images 632 and depth maps 634 for the moving objects. In some embodiments, the functions 628, 630 may represent or be included in the moving object reconstruction operation 328.

The image frames 604 and the depth maps generated by the depth map hole filling function 626 are provided to a static scene image reconstruction function 636, which generates initial images of static scene contents in each image frame 604. An image hole filling function 638 can fill in holes contained in the initial images of the static scene contents. As with the depth maps 618, the initial images of the static scene contents may include holes due to disocclusions, and the image hole filling function 638 can be used to fill in these holes. In some cases, for example, the image hole filling function 638 can use image data from one or more other image frames 604 (possibly after reprojection) in order to fill in one or more holes in the initial image of the static scene contents for a current image frame 604. A static scene boundary refinement function 640 processes the initial images of the static scene contents in order to more accurately define the boundaries of the static scene contents. The static scene boundary refinement function 640 can thereby generate images 642 and depth maps 644 for the static scene contents. In some embodiments, the functions 636, 638, 640 may represent or be included in the real scene reconstruction operation 336.

Although FIG. 6 illustrates one example of a process 600 for scene reconstruction for VST XR, various changes may be made to FIG. 6. For example, various components or functions in FIG. 6 may be combined, further subdivided, replicated, omitted, or rearranged and additional components or functions may be added according to particular needs.

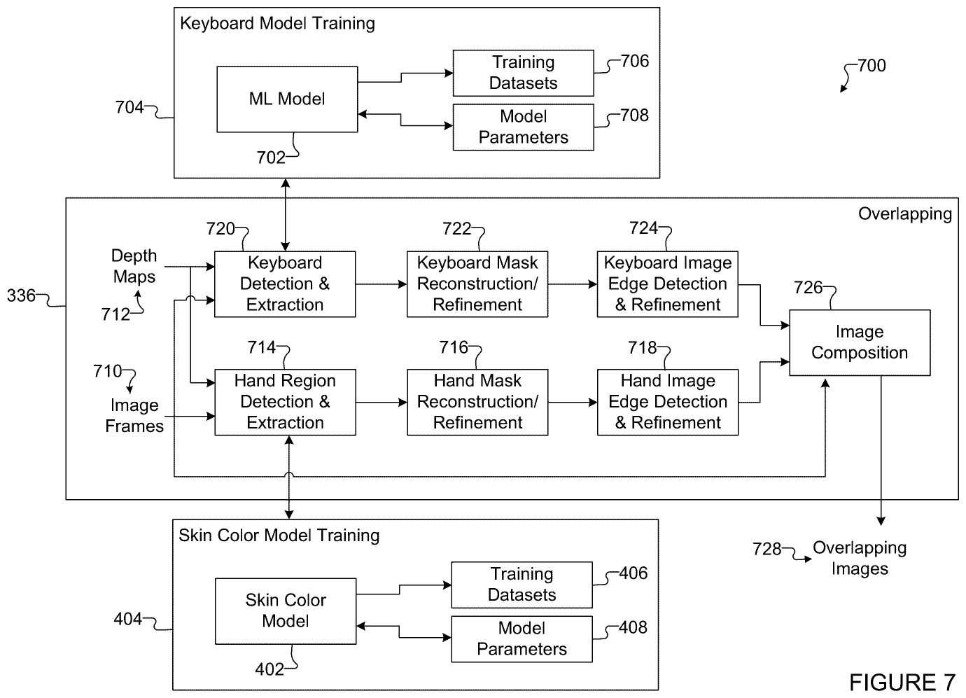

FIG. 7 illustrates an example overlapping process 700 between a moving object and static scene contents for VST XR in accordance with this disclosure. More specifically, FIG. 7 illustrates how the real scene reconstruction operation 336 of the architecture 300 may be used to overlap images of a moving object and static scene contents. For ease of explanation, the process 700 of FIG. 7 is described as being implemented using the electronic device 101 in the network configuration 100 of FIG. 1. However, the process 700 may be implemented using any other suitable device(s) and in any other suitable system(s).

As shown in FIG. 7, the skin color model training operation 404 can be used to train the skin color model 402 as described above. At least one other machine learning (ML) model 702 can also be trained using at least one other training operation 704. The machine learning model 702 can be trained to detect at least one type of object within image frames. In this example, the machine learning model 702 can be trained to detect a keyboard in image frames. The training operation 704 can use one or more training datasets 706 and adjust weights or other parameters 708 of the machine learning model 702. For instance, the one or more training datasets 706 may include training images that do and do not contain keyboards, as well as ground truths identifying which training images contain keyboards and where the training images contain keyboards. The weights or other parameters 708 of the machine learning model 702 can be adjusted until the machine learning model 702 accurately identifies keyboards in training images, at least to within a desired level of accuracy. The machine learning model 702 may represent any suitable machine learning architecture that can be trained to identify keyboards or other objects, such as a deep neural network. Note that the training operation 704 may be performed on the VST XR device, or the training operation 704 could be performed remotely (such as on the server 106) with the resulting trained machine learning model 702 deployed to the VST XR device for use.

The real scene reconstruction operation 336 can obtain image frames 710 and depth maps 712. In some cases, the image frames 710 can be provided by the data capture operation 302, and the depth maps 712 may represent dense depth maps generated by the depth processing operation 316. A hand region detection and extraction function 714 can be used to identify areas of the image frames 710 that capture a user's hands, which can be done using the trained skin color model 402. A hand mask reconstruction and refinement function 716 can be used to generate refined masks associated with the user's hands, such as by smoothing any identified hand masks. A hand image edge detection and refinement function 718 can be used to clearly identify edges or boundaries of the hand masks associated with the user's hand(s), such as by conforming the identified hand masks to the actual contents of the image frames 710.

A keyboard detection and extraction function 720 can be used to identify areas of the image frames 710 that capture a keyboard, which can be done using the trained machine learning model 702. A keyboard mask reconstruction and refinement function 722 can be used to generate refined masks associated with the keyboard, such as by smoothing any identified keyboard masks. A keyboard image edge detection and refinement function 724 can be used to clearly define edges or boundaries of the keyboard masks associated with the keyboard, such as by conforming the identified keyboard masks to the actual contents of the image frames 710.

An image composition function 726 can process the image frames 710, the hand masks, and the keyboard masks in order to generate overlapping images 728. The overlapping images 728 here include images of the user's hands overlapping the keyboard as detected within the image frames 710. In some cases, the keyboard itself can be extracted from the image frames 710 and reconstructed, such as by using the same techniques described above. In those embodiments, images of the reconstructed keyboard may be positioned over images of the reconstructed static scene contents, and images of the reconstructed user's hand(s) can be positioned over images of the reconstructed keyboard.

Although FIG. 7 illustrates one example of an overlapping process 700 between a moving object and static scene contents for VST XR, various changes may be made to FIG. 7. For example, various components or functions in FIG. 7 may be combined, further subdivided, replicated, omitted, or rearranged and additional components or functions may be added according to particular needs.

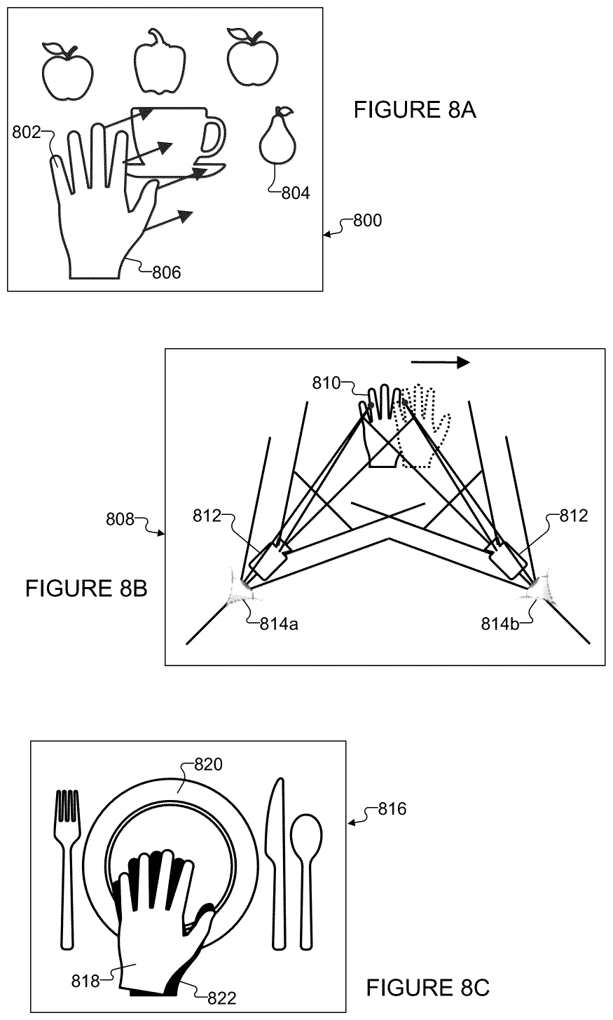

FIGS. 8A through 8C illustrate example use cases for dynamic overlapping of moving objects with real and virtual scenes for VST XR in accordance with this disclosure. More specifically, FIGS. 8A through 8C illustrate example aspects of various operations that can occur within the architectures 200 and 300 described above, where the architectures 200 and 300 can be used to generate overlapping images of moving objects and static scene contents.

As shown in FIG. 8A, a scene 800 being imaged by a VST XR device includes a user's hand 802 moving in front of various objects 804 that form part of static scene contents. As part of the VST XR pipeline, the architecture 200 or 300 can operate to identify the boundary 806 of the user's hand 802 and to track the boundary 806 of the user's hand 802 across multiple image frames. Among other things, this allows the architecture 200 or 300 to effectively overlay images of the user's hand 802 over images of the static scene contents. Moreover, boundary tracking tends to be less computationally intensive than tracking each pixel of the user's hand 802 across the image frames.

As shown in FIG. 8B, a scene 808 being imaged by a VST XR device includes a user's hand 810 that is being moved. At least one see-through camera 812 can be used to generate image frames capturing the user's hand 810, and the image frames can be used to generate images presented to the user. However, the user's head is also moving, so the user may have a head pose 814a when the image frames are captured and a head pose 814b when rendered images based on those image frames are displayed. Note that the change between the head poses 814a-814b is exaggerated for illustration and can be much smaller. The change in head pose can alter the parallax of the user's hand 810. The architecture 200 or 300 can perform parallax correction as described above so that rendered images of the user's hand 810 can be presented at the head pose 814b with the correct parallax.

As shown in FIG. 8C, a scene 816 being imaged by a VST XR device includes a user's hand 818 moving in front of various objects 820 that form part of static scene contents. As part of the VST XR pipeline, the architecture 200 or 300 can identify when holes 822 exist in reconstructed images of the static scene contents. As noted above, the holes 822 can form when the user's hand 818 moves, causing portions of the static scene contents that had been occluded to no longer be occluded. The architecture 200 or 300 can perform hole filling to replace the holes 822 with actual image data. In some cases, this can be accomplished by using image data for the same portions of the static scene contents from other image frames (possibly after reprojection or other processing).

Although FIGS. 8A through 8C illustrate examples of use cases for dynamic overlapping of moving objects with real and virtual scenes for VST XR, various changes may be made to FIGS. 8A through 8C. For example, the specific use cases shown here are examples only, and the architectures 200 and 300 may be used to perform any other suitable operations as described above. Also, scenes being imaged can vary widely, and FIGS. 8A through 8C do not limit the scope of this disclosure to any particular types of scenes.

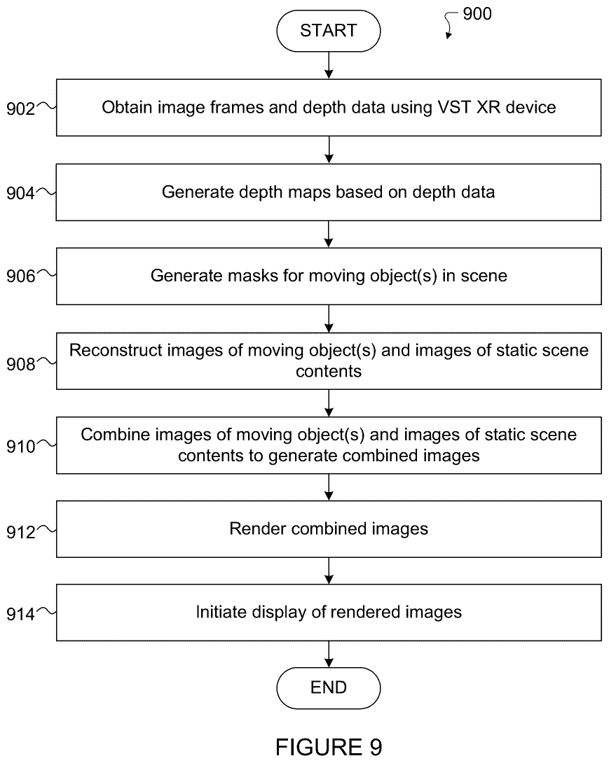

FIG. 9 illustrates an example method 900 for dynamic overlapping of moving objects with real and virtual scenes for VST XR in accordance with this disclosure. For ease of explanation, the method 900 of FIG. 9 is described as being implemented using the electronic device 101 in the network configuration 100 of FIG. 1, which may implement the architecture 200 of FIG. 2 or the architecture 300 of FIG. 3. However, the method 900 may be implemented using any other suitable device(s) and in any other suitable system(s), and the method 900 may be performed using any other suitable architecture(s).

As shown in FIG. 9, image frames and depth data are obtained using a VST XR device at step 902. This may include, for example, the processor 120 of the electronic device 101 obtaining multiple image frames captured using one or more imaging sensors 180 of the VST XR device. The image frames can capture one or more moving objects and static scene contents within the scene, and the moving object(s) may include at least one portion of a body of a user. In some cases, the image frames may be pre-processed, such as by undergoing de-noising and image enhancement. This may also include the processor 120 of the electronic device 101 receiving, generating, or otherwise obtaining depth data associated with the image frames. Depth maps may be generated using the depth data at step 904. This may include, for example, the processor 120 of the electronic device 101 performing depth densification to generate dense depth maps associated with the captured image frames.

Masks for the one or more moving objects in the scene are generated at step 906. This may include, for example, the processor 120 of the electronic device 101 generating one or more binary masks for the moving object(s) in each image frame. At least some of the masks can be generated using a machine learning model trained to separate pixels corresponding to human skin from other portions of the scene, such as a trained skin color model 402. Images of the moving object(s) and images of the static scene contents are reconstructed at step 908. This may include, for example, the processor 120 of the electronic device 101 generating the images of the reconstructed moving object(s) based on the image frames, the depth maps or other depth data, and the masks. This may also include the processor 120 of the electronic device 101 generating the images of the reconstructed static scene contents based on the image frames and the depth maps or other depth data. Part of this may include modifying the images in order to correct for parallax. Part of this may also include performing head pose change compensation based on the estimated latency of the VST XR pipeline.

The images of the reconstructed moving object(s) and the reconstructed static scene contents are combined at step 910. This may include, for example, the processor 120 of the electronic device 101 overlaying the images of the reconstructed moving object(s) over the reconstructed static scene contents. This may also include the processor 120 of the electronic device 101 overlaying one or more virtual features, such as one or more virtual objects or other virtual content, over the images of the reconstructed moving object(s) and the reconstructed static scene contents. This can result in the generation of combined images. Part of this may include performing head pose change compensation based on the estimated latency of the VST XR pipeline. The combined images are rendered at step 912, and display of the resulting rendered images is initiated at step 914. This may include, for example, the processor 120 of the electronic device 101 rendering the combined images and displaying the rendered images on at least one display 160 of the VST XR device.

Although FIG. 9 illustrates one example of a method 900 for dynamic overlapping of moving objects with real and virtual scenes for VST XR, various changes may be made to FIG. 9. For example, while shown as a series of steps, various steps in FIG. 9 may overlap, occur in parallel, occur in a different order, or occur any number of times (including zero times).

It should be noted that the functions shown in or described with respect to FIGS. 2 through 9 can be implemented in an electronic device 101, 102, 104, server 106, or other device(s) in any suitable manner. For example, in some embodiments, at least some of the functions shown in or described with respect to FIGS. 2 through 9 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 9 can be implemented or supported using dedicated hardware components. In general, the functions shown in or described with respect to FIGS. 2 through 9 can be performed using any suitable hardware or any suitable combination of hardware and software/firmware instructions. Also, the functions shown in or described with respect to FIGS. 2 through 9 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining image frames of a scene captured using one or more imaging sensors of a video see-through (VST) extended reality (XR) device and depth data associated with the scene, the image frames capturing a moving object and static scene contents, the moving object comprising a portion of a body of a user;
generating masks associated with the moving object using a machine learning model trained to separate pixels corresponding to human skin from other portions of the scene;
reconstructing images of the moving object based on the image frames, the depth data, and the masks;
reconstructing images of the static scene contents based on the image frames and the depth data;
combining the images of the moving object, the images of the static scene contents, and one or more virtual features to generate combined images; and
rendering the combined images for presentation on at least one display of the VST XR device.

2. The method of claim 1, further comprising:
generating first depth maps associated with the moving object based on the depth data; and
generating second depth maps associated with the static scene contents based on the depth data;
wherein the masks are generated based on the first depth maps;
wherein the images of the moving object are reconstructed based on the image frames, the first depth maps, and the masks; and
wherein the images of the static scene contents are reconstructed based on the image frames and the second depth maps.

3. The method of claim 2, wherein generating the second depth maps comprises:
accessing a previous depth map corresponding to a previous image frame; and
for a current image frame, determining, based on the previous depth map, a depth for each portion of the scene behind the moving object that is disoccluded when the moving object moves.

4. The method of claim 1, further comprising:
correcting for parallax associated with the moving object in the images of the moving object; and
separately correcting for parallax associated with the static scene contents in the images of the static scene contents.

5. The method of claim 1, wherein combining the images of the moving object, the images of the static scene contents, and the one or more virtual features comprises:
overlapping the images of the moving object with the images of the static scene contents based on estimated boundaries of the moving object within the scene.

6. The method of claim 5, wherein combining the images of the moving object, the images of the static scene contents, and the one or more virtual features further comprises:
performing hole filling to generate image content for each portion of the scene behind the moving object that is disoccluded when the moving object moves.

7. The method of claim 1, further comprising:
estimating a latency associated with a pipeline of the VST XR device; and
modifying the images of the moving object and the images of the static scene contents or the combined images based on an estimated head pose of the user when the rendered combined images will be presented to the user.

8. A video see-through (VST) extended reality (XR) device comprising:
one or more imaging sensors;
at least one display; and
at least one processing device configured to:
obtain image frames of a scene captured using the one or more imaging sensors and depth data associated with the scene, the image frames capturing a moving object and static scene contents, the moving object comprising a portion of a body of a user;
generate masks associated with the moving object using a machine learning model trained to separate pixels corresponding to human skin from other portions of the scene;
reconstruct images of the moving object based on the image frames, the depth data, and the masks;
reconstruct images of the static scene contents based on the image frames and the depth data;
combine the images of the moving object, the images of the static scene contents, and one or more virtual features to generate combined images; and
render the combined images for presentation on the at least one display.

9. The VST XR device of claim 8, wherein:
the at least one processing device is further configured to:
generate first depth maps associated with the moving object based on the depth data; and
generate second depth maps associated with the static scene contents based on the depth data;
the at least one processing device is configured to generate the masks based on the first depth maps;
the at least one processing device is configured to reconstruct the images of the moving object based on the image frames, the first depth maps, and the masks; and
the at least one processing device is configured to reconstruct the images of the static scene contents based on the image frames and the second depth maps.

10. The VST XR device of claim 9, wherein, to generate the second depth maps, the at least one processing device is configured to:
access a previous depth map corresponding to a previous image frame; and
for a current image frame, determine, based on the previous depth map, a depth for each portion of the scene behind the moving object that is disoccluded when the moving object moves.

11. The VST XR device of claim 8, wherein the at least one processing device is further configured to:
correct for parallax associated with the moving object in the images of the moving object; and
separately correct for parallax associated with the static scene contents in the images of the static scene contents.

12. The VST XR device of claim 8, wherein, to combine the images of the moving object, the images of the static scene contents, and the one or more virtual features, the at least one processing device is configured to overlap the images of the moving object with the images of the static scene contents based on estimated boundaries of the moving object within the scene.

13. The VST XR device of claim 12, wherein, to combine the images of the moving object, the images of the static scene contents, and the one or more virtual features, the at least one processing device is further configured to perform hole filling to generate image content for each portion of the scene behind the moving object that is disoccluded when the moving object moves.

14. The VST XR device of claim 8, wherein the at least one processing device is further configured to:
estimate a latency associated with a pipeline of the VST XR device; and
modify the images of the moving object and the images of the static scene contents or the combined images based on an estimated head pose of the user when the rendered combined images will be presented to the user.

15. A non-transitory machine readable medium containing instructions that when executed cause at least one processor of a video see-through (VST) extended reality (XR) device to:
obtain image frames of a scene captured using one or more imaging sensors of the VST XR device and depth data associated with the scene, the image frames capturing a moving object and static scene contents, the moving object comprising a portion of a body of a user;
generate masks associated with the moving object using a machine learning model trained to separate pixels corresponding to human skin from other portions of the scene;
reconstruct images of the moving object based on the image frames, the depth data, and the masks;
reconstruct images of the static scene contents based on the image frames and the depth data;
combine the images of the moving object, the images of the static scene contents, and one or more virtual features to generate combined images; and
render the combined images for presentation on at least one display of the VST XR device.

16. The non-transitory machine readable medium of claim 15, further containing instructions that when executed cause the at least one processor to:
generate first depth maps associated with the moving object based on the depth data; and
generate second depth maps associated with the static scene contents based on the depth data;
wherein the instructions when executed cause the at least one processor to:
generate the masks based on the first depth maps;
reconstruct the images of the moving object based on the image frames, the first depth maps, and the masks; and
reconstruct the images of the static scene contents based on the image frames and the second depth maps.

17. The non-transitory machine readable medium of claim 16, wherein the instructions that when executed cause the at least one processor to generate the second depth maps comprise instructions that when executed cause the at least one processor to:
access a previous depth map corresponding to a previous image frame; and
for a current image frame, determine, based on the previous depth map, a depth for each portion of the scene behind the moving object that is disoccluded when the moving object moves.

18. The non-transitory machine readable medium of claim 15, further containing instructions that when executed cause the at least one processor to:
correct for parallax associated with the moving object in the images of the moving object; and
separately correct for parallax associated with the static scene contents in the images of the static scene contents.

19. The non-transitory machine readable medium of claim 15, wherein the instructions that when executed cause the at least one processor to combine the images of the moving object, the images of the static scene contents, and the one or more virtual features comprise instructions that when executed cause the at least one processor to:
overlap the images of the moving object with the images of the static scene contents based on estimated boundaries of the moving object within the scene; and
perform hole filling to generate image content for each portion of the scene behind the moving object that is disoccluded when the moving object moves.

20. The non-transitory machine readable medium of claim 15, further containing instructions that when executed cause the at least one processor to:
estimate a latency associated with a pipeline of the VST XR device; and
modify the images of the moving object and the images of the static scene contents or the combined images based on an estimated head pose of the user when the rendered combined images will be presented to the user.
